(19) United States
(12) Patent Application Publication
(10) Pub. No.: US 2025/0282677 A1
(43) Pub. Date: Sep. 11, 2025

(54) METHOD OF FORMING A TIN OXIDE COATING

(71) Applicant: Pilkington Group Limited, Lathom (GB)

(72) Inventors: David Alan STRICKLER, Toledo, OH (US); Vikash RANJAN, Perrysburg, OH (US)

(21) Appl. No.: 18/861,900

(22) PCT Filed: May 3, 2023
(86) PCT No.: PCT/GB2023/051165

§ 371 Date: Oct. 31, 2024

Related U.S. Application Data
(60) Provisional application No. 63/337,748, filed on May 3, 2022.

(51) Int. Cl. C03C 17/245

(52) U.S. Cl. CPC C03C 17/2453; C03C 2217/211; C03C 2218/1525

(57) ABSTRACT

A chemical vapor deposition process for forming a tin oxide coating includes providing a moving glass substrate. A gaseous mixture is formed and includes at least one tin compound, at least one oxygen-containing molecule, and at least one sulfur-containing compound. The gaseous mixture is directed toward and along the glass substrate. The gaseous mixture is reacted to form the tin oxide coating over the glass substrate.

### FIELD OF THE INVENTION

The subject matter of the embodiments described herein relates generally to a method of forming a tin oxide coating and, more particularly, to a method of forming a tin oxide coating utilizing a gaseous mixture comprising a sulfur-containing compound to enhance the growth rate and/or desired properties of the tin oxide coating.

### BACKGROUND OF THE INVENTION

The present invention relates to processes for producing coated substrates and to substrates having such coatings on at least one surface. The present invention also relates to glazings comprising such coated substrates, in particular automotive and architectural glazings.

Coatings on substrates, especially glass substrates, may be used to modify the properties of the substrate. A number of methods may be used to deposit coatings including many liquid-based methods such as spin coating, dip coating, spray coating, and various printing techniques. One conventional method for depositing a coating on a substrate is chemical vapor deposition (CVD) wherein a fluid precursor in the form of a vapor is delivered to a surface of the substrate where the precursors react and/or decompose thereby depositing the coating. Particular types of CVD include metal organic (MO) CVD, combustion (C) CVD, plasma enhanced (PE) CVD, and aerosol-assisted (AA) CVD.

It is known to deposit a tin oxide coating on a substrate. However, the processes known for the forming of such tin oxide coating are limited by an efficiency of the deposition process and by powder formation of the reactive elements.

Accordingly, it would be desirable to develop a method of forming a tin oxide coating, which improves the process for forming a tin oxide coating over a substrate, while enhancing a growth rate and/or desired properties thereof.

### SUMMARY OF THE INVENTION

In concordance and agreement with the present disclosure, a method of forming a tin oxide coating, which utilizes a gaseous mixture comprising a sulfur-containing compound to enhance a growth rate and/or desired properties of the tin oxide coating, has surprisingly been discovered.

In one embodiment, a chemical vapor deposition method for forming a tin oxide coating, comprises: providing a glass substrate; forming a precursor gaseous mixture comprised of at least one tin compound, a first oxygen-containing molecule, and at least one sulfur-containing compound; directing the precursor gaseous mixture toward and along the glass substrate; and reacting the precursor gaseous mixture to form the tin oxide coating over the glass substrate.

As aspects of certain embodiments, the at least one tin compound is at least one of dimethyltin dichloride, diethyltin dichloride, dibutyltin diacetate, tetra methyl tin, methyltin trichloride, triethytin chloride, trimethyltin chloride, ethyltin trichloride, propyltin trichloride, isopropyltin trichloride, sec-butyltin trichloride, t-butyltin trichloride, phenyltin trichloride, carbethoxyethyltin trichloride.

As aspects of certain embodiments, the at least one sulfur-containing compound is an organic sulfur-containing compound.

As aspects of certain embodiments, the at least one sulfur-containing compound is at least one of dimethyl sulfoxide and di-tert-butyl disulfide.

As aspects of certain embodiments, the at least one sulfur-containing compound is dimethyl sulfoxide.

As aspects of certain embodiments, a temperature of the glass substrate is at least 750° F. (399° C.) when the precursor gaseous mixture is reacted during the chemical vapor deposition process.

As aspects of certain embodiments, a temperature of the glass substrate is between about 840° F. (449° C.) and about 1300° F. (704° C.) when the precursor gaseous mixture is reacted during the chemical vapor deposition process.

As aspects of certain embodiments, the glass substrate comprises soda-lime-silica glass.

As aspects of certain embodiments, the glass substrate is formed by a float glass process.

As aspects of certain embodiments, the at least one sulfur-containing compound is added to the precursor gaseous mixture at a rate of at least 3 cc/min.

As aspects of certain embodiments, the at least one sulfur-containing compound is added to the precursor gaseous mixture at a rate in range of about 3 cc/min to about 15 cc/min.

As aspects of certain embodiments, the precursor gaseous mixture is reacted over the glass substrate at essentially atmospheric pressure.

As aspects of certain embodiments, the glass substrate is moving when the tin oxide coating is deposited.

As aspects of certain embodiments, the tin oxide coating is an outermost layer of a coated glass article.

As aspects of certain embodiments, the tin oxide coating is formed over a previously deposited layer on the glass substrate.

As aspects of certain embodiments, the tin oxide coating has a thickness in a range of about 1200 Angstroms to about 1800 Angstroms.

As aspects of certain embodiments, the tin oxide coating has a thickness in a range of about 1500 Angstroms to about 1600 Angstroms.

As aspects of certain embodiments, the tin oxide coating has a thickness in a range of about 1750 Angstroms to about 3000 Angstroms.

As aspects of certain embodiments, the tin oxide coating has a thickness in a range of about 2200 Angstroms to about 2750 Angstroms.

As aspects of certain embodiments, the tin oxide coating has a sheet resistance in a range of about 250 ohms/square and 1000 ohms/square.

As aspects of certain embodiments, the tin oxide coating has a sheet resistance in a range of about 1250 ohms/square and 2250 ohms/square.

As aspects of certain embodiments, the first oxygen-containing molecule is molecular oxygen.

As aspects of certain embodiments, the precursor gaseous mixture further comprises a second oxygen-containing molecule.

As aspects of certain embodiments, the second oxygen-containing molecule is water vapor.

As aspects of certain embodiments, the first oxygen-containing molecule is molecular oxygen and the second oxygen-containing molecule is water vapor.

As aspects of certain embodiments, the at least one tin compound is dimethyltin dichloride, the first oxygen-containing molecule is molecular oxygen and the at least one sulfur-containing compound is dimethyl sulfoxide.

As aspects of certain embodiments, the precursor gaseous mixture further comprises a second oxygen-containing molecule, and wherein the at least one tin compound is dimethyltin dichloride, the first oxygen-containing molecule is molecular oxygen, the second oxygen-containing molecule is water vapor, and the at least one sulfur-containing compound is dimethyl sulfoxide.

As aspects of certain embodiments, the tin oxide coating is pyrolytic. As used herein, the term “pyrolytic” refers to a coating or a layer thereof that is chemically bonded to the glass substrate or a previously deposited layer on the glass substrate.

As aspects of certain embodiments, the precursor gas mixture further comprises at least one fluorine-containing compound.

As aspects of certain embodiments, the at least one fluorine-containing compound is at least one of hydrofluoric acid and trifluoroacetic acid.

As aspects of certain embodiments, the precursor gaseous mixture further comprises a second oxygen-containing molecule and at least one fluorine-containing compound, and wherein the at least one tin compound is dimethyl tin dichloride, the first oxygen-containing molecule is molecular oxygen, the second oxygen-containing molecule is water vapor, the at least one sulfur-containing compound is dimethyl sulfoxide, and the at least one fluorine-containing compound is hydrofluoric acid.

As aspects of certain embodiments, the tin oxide coating has a thickness in a range of about 3000 Angstroms to about 5000 Angstroms.

As aspects of certain embodiments, the tin oxide coating has a thickness in a range of about 3800 Angstroms to about 4800 Angstroms.

As aspects of certain embodiments, the tin oxide coating has a sheet resistance in a range of about 8 ohms/square to about 14 ohms/square.

As aspects of certain embodiments, the tin oxide coating has a sheet resistance in a range of about 16 ohms/square to about 20 ohms/square.

In another embodiment, a method of coating a substrate, comprises: providing a glass substrate; and forming a tin oxide coating on the substrate using a chemical vapor deposition process, wherein the chemical vapor deposition process utilizes a precursor gaseous mixture comprising at least one tin compound, a first oxygen-containing molecule, and at least one sulfur-containing compound, wherein the at least one sulfur-containing compound acts as an accelerant for a reaction which forms the tin oxide coating over the glass substrate.

In yet another embodiment, a coated glass article, comprises: a glass substrate; and a tin oxide coating deposited over the glass substrate by a chemical vapor deposition process utilizing a gaseous mixture comprising at least one tin compound, a first oxygen-containing molecule, and at least one sulfur-containing compound, wherein the sulfur-containing compound acts as an accelerant for a reaction which forms the tin oxide coating over the glass substrate.

### BRIEF DESCRIPTION OF THE DRAWINGS

The above, as well as other objects and advantages of the subject matter of the embodiments described herein, will become readily apparent to those skilled in the art from a reading of the following detailed description of the embodiments when considered in the light of the accompanying drawings in which:

FIG. 1 is a chart providing actual results for a coated glass article showing total thickness of undoped tin oxide coatings formed using a first gaseous mixture comprising a tin compound, various amounts of a sulfur-containing compound of dimethyl sulfoxide and a first oxygen-containing molecule of molecular oxygen, and total thickness of undoped tin oxide coatings formed using a second gaseous mixture comprising a tin compound, various amounts of a sulfur-containing compound of dimethyl sulfoxide, a first oxygen-containing molecule of molecular oxygen, and a second oxygen-containing molecule of water (H₂O) vapor.

FIG. 2 is a chart providing actual results for a coated glass article showing a sheet resistance of undoped tin oxide coatings formed using a gaseous mixture comprising a tin compound, various amounts of a sulfur-containing compound of dimethyl sulfoxide and a first oxygen-containing molecule of molecular oxygen, and a sheet resistance of undoped tin oxide coatings formed using a gaseous mixture comprising a tin compound, various amounts of a sulfur-containing compound of dimethyl sulfoxide, a first oxygen-containing molecule of molecular oxygen, and a second oxygen-containing molecule of water (H₂O) vapor;

FIG. 3 is a chart providing actual results for a coated glass article showing a total thickness of fluorine-doped tin oxide coatings formed using a first gaseous mixture comprising various amounts of a tin compound, various amounts of a sulfur-containing compound of dimethyl sulfoxide, a first oxygen-containing molecule of molecular oxygen, a second oxygen-containing molecule of water (H₂O) vapor, and a fluorine-containing compound.

FIG. 4 is a chart providing actual results for a coated glass article showing a sheet resistance of fluorine-doped tin oxide coatings formed using a gaseous mixture comprising various amounts of a tin compound, various amounts of a sulfur-containing compound of dimethyl sulfoxide, a first oxygen-containing molecule of molecular oxygen, a second oxygen-containing molecule of water (H₂O) vapor, and a fluorine-containing compound; and

FIG. 5 is a schematic view, in vertical section, of an installation for practicing a float glass manufacturing process in accordance with an embodiment of the subject matter.

### DETAILED DESCRIPTION OF THE INVENTION

It is to be understood that the presently disclosed subject matter may assume various alternative orientations and step sequences, except where expressly specified to the contrary.

It is also to be understood that the specific articles, apparatuses and processes described in the following specification are simply exemplary embodiments of the inventive concepts. Hence, specific dimensions, directions, or other physical properties relating to the embodiments disclosed are not to be considered as limiting, unless expressly stated otherwise. Also, although they may not be, like elements in the various embodiments described within this section of the application may be commonly referred to with like reference numerals.

Any feature set out above in relation to the first aspect of the present invention may also be utilised in relation to any other aspects of the present invention. Any invention described herein may be combined with any feature of any other invention described herein mutatis mutandis.

It will be appreciated that optional features applicable to one aspect of the invention can be used in any combination, and in any number. Moreover, they can also be used with any of the other aspects of the invention in any combination and in any number. This includes, but is not limited to, the dependent claims from any claim being used as dependent claims for any other claim in the claims of this application.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

Throughout this specification, the term “comprising” or “comprises” means including the component(s) specified but not to the exclusion of the presence of other components. Whenever appropriate, depending upon the context, the use of the term “comprises” or “comprising” may also be taken to include the meaning “consists essentially of” or “consisting essentially of”, and also may also be taken to include the meaning “consists of” or “consisting of”.

References herein such as “in the range x to y” are meant to include the interpretation “from x to y” and so include the values x and y.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

A method for forming a tin oxide coating according to one embodiment of the presently disclosed subject matter is a chemical vapor deposition process for forming the tin oxide coating (hereinafter referred to as the “CVD process”).

The CVD process will be described in connection with a coated glass article. It should be appreciated that the coated glass article may have numerous applications across various products and industries. For example, the coated glass article may be utilized in solar cell applications, architectural glazings, electronics, and automotive and aerospace applications.

The tin oxide coating comprises tin and oxygen. The tin oxide coating of the presently described subject matter is formed using a sulfur-containing compound. In some of these embodiments, the tin oxide coating may include a trace amount of one or more additional constituents such as, for example, carbon, sulfur, etc. As used herein, the phrase “trace amount” is an amount of a constituent of the tin oxide coating that is less than 0.01 weight %, or equivalently, less than 100 ppm. In certain embodiments, the tin oxide coating is doped with fluorine and formed using a fluorine-containing compound. Both the undoped tin oxide coating and the fluorine-doped tin oxide coating are collectively referred to herein as the “tin oxide coating”, unless specifically described otherwise.

A feature of the CVD process is that it allows for the formation of tin oxide coatings at commercially viable deposition rates. Additionally, an advantage of the CVD process is that it is more efficient than known processes for forming the tin oxide coating. Thus, commercially viable deposition rates can be achieved using less tin containing compound than in the known processes, which reduces the cost to form the tin oxide coating.

The tin oxide coating may be formed over a substrate. It should be appreciated that the tin oxide coating may be formed directly on the substrate or on a coating previously deposited on the substrate. In some embodiments, the tin oxide coating may be formed directly on a glass substrate. Alternatively, the tin oxide coating may be formed directly on a previously deposited tin oxide coating or a titanium dioxide coating. In a preferable embodiment, the tin oxide coating may be formed over the glass substrate, wherein the glass substrate has a deposition surface over which the tin oxide coating is formed. In another preferable embodiment, the tin oxide coating may be formed over a silicon oxide coating disposed on a tin oxide substrate or a tin oxide coating deposited on the glass substrate. Yet, in another preferable embodiment, the tin oxide coating may be formed over a titanium dioxide substrate or a previously deposited tin oxide coating or a titanium dioxide coating, which was formed over a deposition surface of the glass substrate. In this embodiment, the tin oxide coating or the titanium dioxide coating, over which the tin oxide coating may be deposited, may be doped with fluorine or deposited directly on the glass substrate. In this position, the tin oxide coating may act as a sodium diffusion barrier between the glass substrate and any coatings formed over the tin oxide coating. This may be particularly advantageous when the glass substrate is a soda-lime-silica glass.

The CVD process may be carried out in conjunction with the manufacture of the glass substrate. In an embodiment, the glass substrate may be formed utilizing the well-known float glass manufacturing process. In this embodiment, the glass substrate may also be referred to as a glass ribbon. However, it should be appreciated that the CVD process can be utilized apart from the float glass manufacturing process or well after formation and cutting of the glass ribbon.

In certain embodiments, the CVD process is a dynamic deposition process. In these embodiments, the glass substrate is moving at the time of forming the tin oxide coating. Preferably, the glass substrate moves at a predetermined rate of, for example, greater than 3.175 m/min (125 in/min) as the tin oxide coating is being formed. In an embodiment, the glass substrate is moving at a rate of between 3.175 m/min (125 in/min) and 12.7 m/min (600 in/min) as the tin oxide coating is being formed.

In certain embodiments, the glass substrate is heated. In an embodiment, the temperature of the glass substrate is about 1100° F. (593° C.) or more when the tin oxide coating is formed. In another embodiment, the temperature of the glass substrate is between 1100° F. (593° C.) and 1400° F. (760° C.) when the tin oxide coating is formed thereon.

Preferably, the tin oxide coating is deposited over the deposition surface of the glass substrate while the surface is at essentially atmospheric pressure. In this embodiment, the CVD process is an atmospheric pressure CVD (APCVD) process. However, the CVD process is not limited to being an APCVD process as, in other embodiments, the tin oxide coating may be formed under low-pressure conditions.

The glass substrate is not limited to a particular thickness. In an embodiment, the glass substrate is a soda-lime-silica glass. In some embodiments, the substrate may be a portion of the float glass ribbon. However, the CVD process is not limited to a soda-lime-silica glass substrate as, in other embodiments, the glass substrate may be a borosilicate or aluminosilicate glass.

Also, the transparency or absorption properties of the glass substrate may vary between embodiments. For example, in certain embodiments, it may be preferable to utilize a glass substrate having a low iron content, which allows the glass substrate to exhibit a high visible light transmittance. In some embodiments, the glass substrate may comprise 0.15 weight % Fe₂O₃ (total iron) or less. As used herein, the phrase “total iron” refers to the total weight of iron oxide (FeO+Fe₂O₃) contained in the glass. More preferably, the glass substrate comprises 0.1 weight % Fe₂O₃ (total iron) or less, and, even more preferably, a 0.02 weight % Fe₂O₃ (total iron) or less. In an embodiment, the glass substrate comprises 0.012 weight % Fe₂O₃ (total iron). In these embodiments, the glass substrate may exhibit a total visible light transmittance of 91% or more in the CIELAB color scale system (Illuminant C, ten-degree observer). Further, the color of the glass substrate can vary between embodiments of CVD process. In an embodiment, the glass substrate may be substantially clear. In other embodiments, the glass substrate may be tinted or colored such as bronze or gray, for example.

Preferably, the tin oxide coating may be deposited by forming a gaseous mixture comprised of one or more reactant (precursor) molecules. It is preferred that the precursor molecules suitable for use in the gaseous mixture are suitable for use in a CVD process. Such molecules may at some point be a liquid or a solid but are volatile such that they can be vaporized for use in the gaseous mixture. In certain embodiments, the gaseous mixture includes precursor molecules suitable for forming the tin oxide coating at essentially atmospheric pressure. Once in a gaseous state, the precursor molecules can be included in a gaseous stream and utilized to form the tin oxide coating.

For any particular combination of gaseous precursor molecules, the optimum concentrations and flow rates for achieving a particular deposition rate and coating thickness may vary. To form the tin oxide coating of the presently described subject matter, it is preferred that the gaseous mixture comprises may comprise one or more tin compounds and one or more sulfur-containing compounds. Preferably, in certain embodiments, the gaseous mixture may be comprised of one or more tin compounds, one or more oxygen-containing molecules, and one or more sulfur-containing compounds. More preferably, in other embodiments, the gaseous mixture may be comprised of one or more tin compounds, one or more oxygen-containing molecules, one or more sulfur-containing compounds, and one or more fluorine-containing compounds. As used herein, the phrases “reactant molecules” and “precursor molecules” may be used interchangeably to refer to any or all of the one or more tin compounds, the one or more oxygen-containing molecules, the one or more sulfur-containing compounds, and the one or more fluorine-containing compounds, used to describe the various embodiments thereof disclosed herein.

Utilizing the embodiments of the gaseous mixture described above results in the deposition of a high-quality coating layer over the glass substrate may be substantially free from defects. Also, the tin oxide coating may exhibit excellent coating thickness uniformity. In some embodiments, the tin oxide coating may be pyrolytic.

Each of the one or more tin compounds, the one or more oxygen-containing molecules, the one or more sulfur-containing compounds, and the one or more fluorine-containing compounds may be supplied from a source thereof. Separate supply lines may extend from the sources of the one or more tin compounds, the one or more oxygen-containing molecules, the one or more sulfur-containing compounds, and the one or more fluorine-containing compounds. Preferably, the sources of the precursor molecules may be provided at a location outside the float bath chamber.

In one embodiment, the tin oxide coating may be undoped tin oxide (SnO₂). In another embodiment, the tin oxide coating may be fluorine-doped tin oxide (SnO₂:F). In both such embodiments, the one or more tin compounds included in the gaseous mixture may be at least one of dimethyltin dichloride (DMT), diethyltin dichloride, dibutyltin diacetate, tetra methyl tin, methyltin trichloride, triethytin chloride, trimethyltin chloride, ethyltin trichloride, propyltin trichloride, isopropyltin trichloride, sec-butyltin trichloride, t-butyltin trichloride, phenyltin trichloride, carbethoxyethyltin trichloride. However, it is understood that one or more other suitable tin compounds may be included in the gaseous mixture.

In an embodiment, the one or more sulfur-containing compounds in the gaseous mixture may be an organic sulfur-containing compound. More preferably, the one or more sulfur-containing compounds in the gaseous mixture may be dimethyl sulfoxide (DMSO). In another embodiment, the one or more sulfur-containing compound in the gaseous mixture may be di-tert-butyl disulfide. It is understood that other embodiments may employ any suitable sulfur-containing compound for use in the gaseous mixture as desired.

In some embodiments, when the gaseous mixture comprises the one or more sulfur-containing compounds, the tin oxide coating may comprise a trace amount (as defined herein) or more of sulfur. In other embodiments, when the gaseous mixture comprises the one or more sulfur-containing compounds, the tin oxide coating may comprise a trace amount (as defined herein) or less of sulfur.

In some embodiments, the gaseous mixture of the one or more tin compounds and the one or more sulfur-containing compounds may further comprise one or more oxygen-containing molecules. However, it should be appreciated that the phrase “one or more oxygen-containing molecules” refers to one or more molecules included in the gaseous mixture that are separate from the one or more tin compounds, and the one or more sulfur-containing compounds. The one or more oxygen-containing molecules may comprise a first oxygen-containing molecule. In an embodiment, the first oxygen-containing molecule may be molecular oxygen (O₂), which can be provided as a part of a gaseous composition such as air or in a substantially purified form. In another embodiment, the first oxygen-containing molecule may be water (H₂O) vapor, which may be provided as steam. In certain embodiments, the one or more oxygen-containing molecules may comprise two oxygen-containing molecules. More preferably, the gaseous mixture may comprise the first oxygen-containing molecule and a second oxygen-containing molecule. In this embodiment, the first oxygen-containing molecule may be molecular oxygen and the second oxygen-containing molecule may be water vapor or vice versa. In some embodiments, the gaseous mixture may comprise more water vapor than molecular oxygen. In preferred embodiments, the molecular percentage of the second oxygen-containing compound in the gaseous mixture may be between 0 vol. % and 50 vol. %.

It has been surprisingly discovered that with an addition of the one or more sulfur-containing compounds to such gaseous mixture may result in an increase in an optical thickness of the tin oxide coating. In a non-limiting example, the gaseous mixture comprising the one or more tin compounds with the addition of the one or more sulfur-containing compounds and only the first oxygen-containing molecule (e.g. molecular oxygen (O₂)) may result in about a 100% increase in the optical thickness of the tin oxide coating over an optical thickness of prior tin oxide coatings formed using molecular oxygen (O₂) but no water (H₂O) vapor or a sulfur-containing compound. It has been further surprisingly discovered that when the gaseous mixture comprises two oxygen-containing molecule such as, for example, the first oxygen-containing molecule being molecular oxygen (O₂) and the second oxygen-containing molecule being water (H₂O) vapor along with the one or more sulfur-containing compounds, a further increase in the optical thickness of the tin oxide coating may be realized. In a non-limiting example, the gaseous mixture comprising the one or more tin compounds with the addition of the one or more sulfur-containing compounds and both the first oxygen-containing molecule (e.g. molecular oxygen (O₂)) and the second oxygen-containing molecule (e.g. water (H₂O) vapor) may result in about a 10% to about a 20% increase in the optical thickness of the tin oxide coating over an optical thickness of prior tin oxide coatings formed using molecular oxygen (O₂) and water (H₂O) vapor but no sulfur-containing compound.

The benefits of utilizing the one or more sulfur-containing compounds, like the embodiments described above, to form the tin oxide coating can be realized by selecting a preferred volume percentage of the one or more sulfur-containing compounds in the gaseous mixture. In certain embodiments, the volume percentage of the one or more sulfur-containing compounds in the gaseous mixture may be between about 0 vol. % and about 4 vol. % in total gas flow. In certain preferred embodiments, the molecular percentage of the one or more sulfur-containing compounds in the gaseous mixture may be between 0.1 vol. % and 0.7 vol. %. More preferably, the molecular percentage of the one or more sulfur-containing compounds in the gaseous mixture may be between 0.1 vol. % and 0.7 vol. % when the gaseous mixture comprises only the first oxygen-containing molecule (e.g. molecular oxygen (O₂)) and does not comprise the second oxygen-containing molecule (e.g. water (H₂O) vapor).

In some embodiments, it may be desired to limit the amount of the one or more sulfur-containing compounds in the gaseous mixture. In one such embodiment, the molecular percentage of the one or more sulfur-containing compounds in the gaseous mixture may be less than 0.7 vol. %. In another embodiment, the gaseous mixture may comprise 0.3 vol. % or less of the one or more sulfur-containing compounds. Preferably, the molecular percentage of one or more the sulfur-containing compounds in the gaseous mixture may be between 0.1vol. % and 0.5 vol. %, more preferably between 0.1 vol. % and 0.3 vol. %. Preferably, the molecular percentage of the one or more sulfur-containing compounds in the gaseous mixture may be between 0.1 vol. % and 1.25 vol. %, more preferably between 0.1 vol. % and 0.7 vol. %, even more preferably between 0.1 vol. % and 0.5 vol. %, even more preferably between 0.1 vol. % and 0.3 vol. % when the gaseous mixture further comprises a second oxygen-containing molecule (e.g. water (H₂O) vapor).

In some embodiments, the one or more sulfur-containing compounds may be added to the gaseous mixture at a rate of at least 1 cc/min. Preferably, the one or more sulfur-containing compounds may be added to the gaseous mixture at a rate in range of about 1 cc/min to about 13 cc/min, and more preferably, at a rate in range of about 1 cc/min to about 9 cc/min.

In the embodiments directed to the fluorine-doped tin oxide coating, the gaseous mixture further comprises the one or more fluorine-containing compounds. Any suitable fluorine-containing compounds may be included in the gaseous mixture such as hydrofluoric acid, trifluoroacetic acid, for example.

The gaseous mixture may also comprise one or more inert gases utilized as carrier or diluent gas. Suitable inert gases may include at least one of nitrogen (N₂), helium (He), and mixtures thereof. Thus, sources of the one or more inert gases, from which separate supply lines may extend, may be provided.

The precursor molecules are mixed to form the gaseous mixture. As described above, the one or more tin compounds may be mixed with the one or more oxygen-containing molecules. When provided, it is preferred that the one or more sulfur-containing compounds may be also mixed with the one or more tin compounds and the one or more oxygen-containing molecules to produce the undoped tin oxide coating. More preferably, the one or more fluorine-containing compounds may be mixed with the one or more tin compounds, the one or more sulfur-containing compounds, and the one or more oxygen-containing molecules to produce the fluorine-doped tin oxide coating.

In certain embodiments, a coating apparatus may be provided. Preferably, the gaseous mixture may be fed through the coating apparatus before forming the tin oxide coating on the glass substrate. The gaseous mixture may be discharged from the coating apparatus utilizing one or more gas distributor beams. Preferably, the gaseous mixture may be formed prior to being fed through the coating apparatus. For example, the precursor molecules may be mixed in a feed line connected to an inlet of the coating apparatus. In other embodiments, the gaseous mixture may be formed within the coating apparatus.

An advantage of the CVD process described herein may be the significant increase in the thickness of the tin oxide coating, the increase in the deposition rate that occurs, and/or the reduction in the amount of pre-reaction/powder formation that occurs when forming the tin oxide coating. Hence, the CVD process can be operated for run lengths which are much greater than those of conventional processes. Depending on the thickness of the tin oxide coating required, the coating formed by the CVD process may be deposited by forming a plurality of tin oxide coating layers consecutively. However, depending on the desired thickness, another advantage of the CVD process is that only a single coating apparatus may be required for forming the tin oxide coating.

Preferably, the coating apparatus extends transversely across the glass substrate and may be provided at a predetermined distance there above. The coating apparatus may be preferably located at one or more predetermined locations. When the CVD process may be utilized in conjunction with the float glass manufacturing process, the coating apparatus may be preferably provided within the float bath section thereof. However, the coating apparatus may be provided in the annealing lehr, and/or in the gap between the float bath and the annealing lehr.

The gaseous mixture may be directed toward and along the glass substrate. Utilizing a coating apparatus aids in directing the gaseous mixture toward and along the glass substrate. Preferably, the gaseous mixture may be directed toward and along the glass substrate in a laminar flow. The gaseous mixture reacts at or near the glass substrate to form the tin oxide coating thereover.

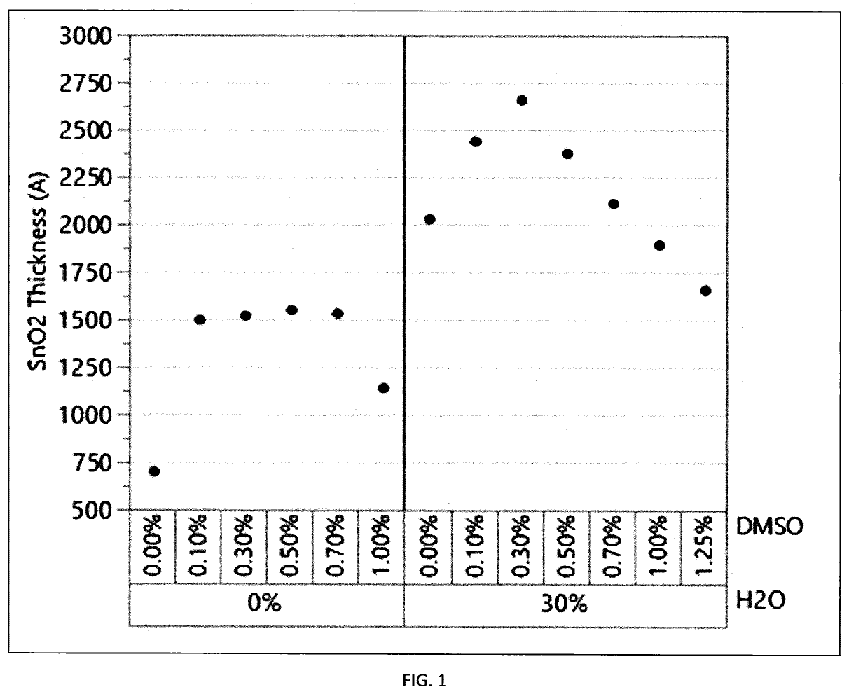

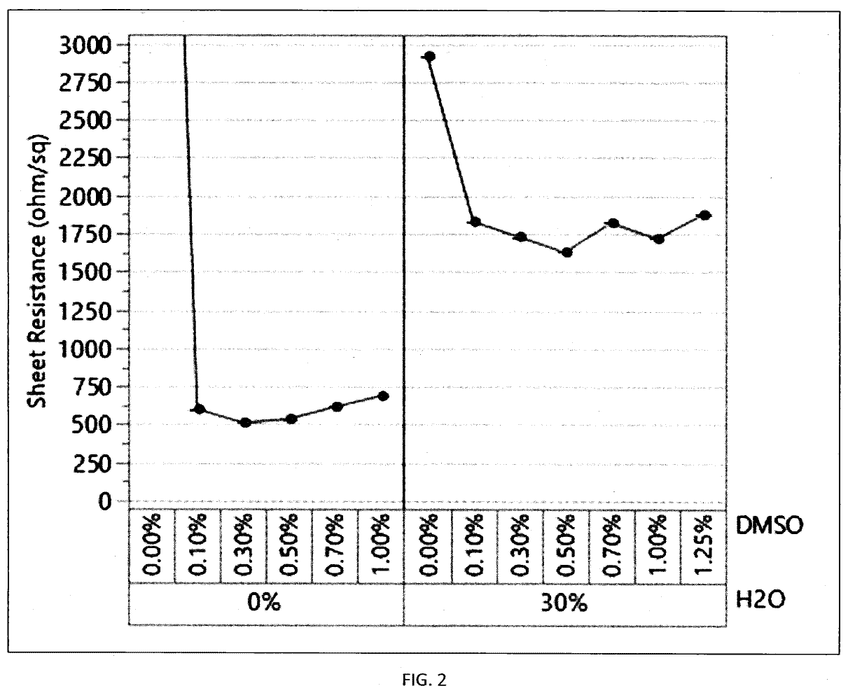

FIGS. 1 and 2 are charts providing actual results for examples of a coated glass article including a mid-iron, soda-lime-silica glass substrate with a undoped tin oxide coating formed using one of a first gaseous mixture or a second gaseous mixture according to the presently described subject matter.

In such examples, the first gaseous mixture comprised of 0.0 vol. % to 1.0 vol. % dimethyl sulfoxide (DMSO), 3.0 vol. % dimethyltin dichloride (DMT), and 20 vol. % molecular oxygen was reacted over the glass substrate which resulted in an undoped tin oxide coating having a total thickness in a range of about 600 Angstroms to about 1625 Angstroms and a sheet resistance in a range of about 250 ohms/square to over 3000 ohms/square. As shown in FIG. 1, the total thickness of the undoped tin oxide coating increased by about 100% over a total thickness of prior tin oxide coatings to a range of about 1200 Angstroms to about 1625 Angstroms when the gaseous mixture comprised about 0.1 vol. % to about 0.7% of dimethyl sulfoxide (DMSO) and no water (H₂O) vapor. Additionally, as illustrated in FIG. 2, the sheet resistance of the undoped tin oxide coating decreased to between about 250 ohms/square and 1000 ohms/square when the gaseous mixture comprised about 0.1 vol. % to about 1.0% of dimethyl sulfoxide (DMSO) and no water (H₂O).

In such examples, the second gaseous mixture comprised of 0.0 vol. % to 1.25 vol. % dimethyl sulfoxide (DMSO), 3.0 vol. % dimethyltin dichloride (DMT), 15 vol. % molecular oxygen, and 30 vol. % water (H₂O) vapor, was reacted over the glass substrate which resulted in an undoped tin oxide coating having a total thickness in a range of about 1600 Angstroms to about 3000 Angstroms and a sheet resistance in a range of about 1500 ohms/square to about 3000 ohms/square. As shown in FIG. 1, the total thickness of the undoped tin oxide coating increased by about 10% to about 20% over the total thickness of prior tin coatings to a range of about 2000 Angstroms to about 2750 Angstroms when the gaseous mixture comprised about 0.1 vol. % to about 0.5% of dimethyl sulfoxide (DMSO) and 30 vol. % water (H₂O) vapor. As illustrated in FIG. 2, the sheet resistance of the undoped tin oxide coating decreased to between about 1250 ohms/square and 2250 ohms/square when the gaseous mixture comprised about 0.1 vol. % to about 1.25% of dimethyl sulfoxide (DMSO) and 30 vol. % water (H₂O) vapor.

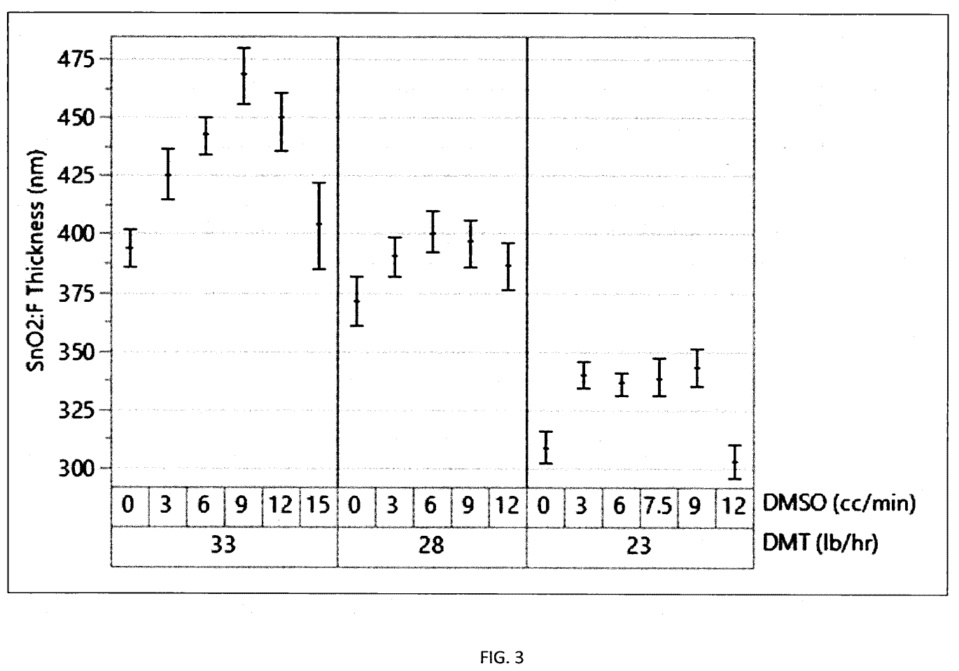

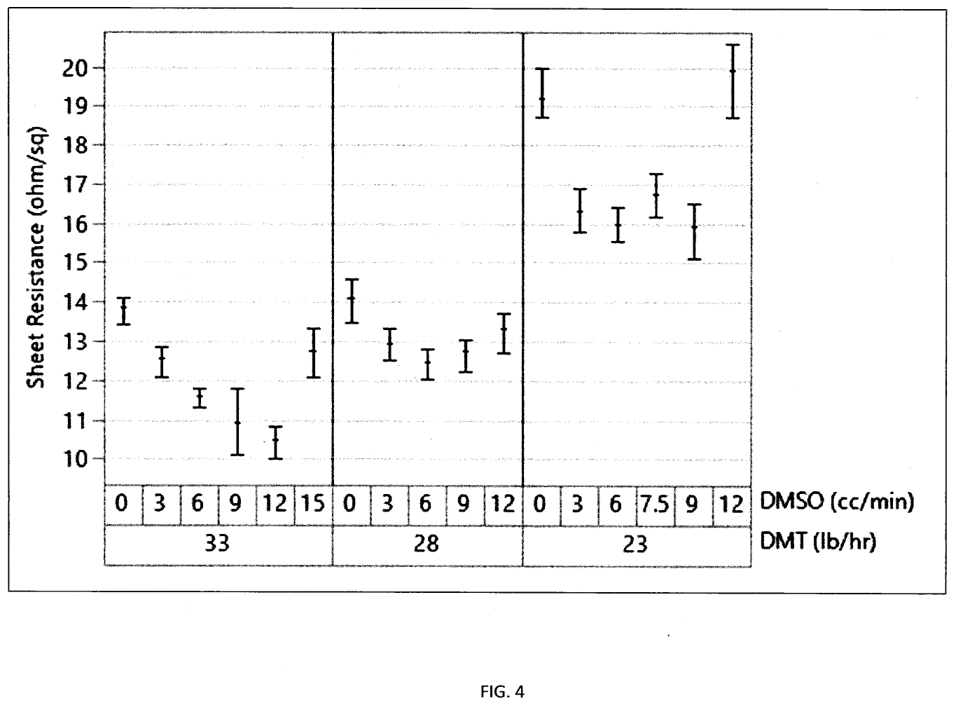

FIGS. 3 and 4 are charts providing actual results for examples of a coated glass article including a mid-iron, soda-lime-silica glass substrate with a fluorine-doped tin oxide coating formed using a third gaseous mixture according to the presently described subject matter.

In such examples, the third gaseous mixture comprised of 0 cc/min to 15 cc/min of dimethyl sulfoxide (DMSO) added into 23 lb./hr. to 33 lb./hr. of dimethyltin dichloride (DMT), molecular oxygen, water (H₂O) vapor, and hydrofluoric acid, was reacted over the glass substrate which resulted in a fluorine-doped tin oxide coating having a total thickness in a range of about 2500 Angstroms to about 5000 Angstroms, as shown in FIG. 3, and a sheet resistance in a range of about 8 ohms/square to about 25 ohms/square, as shown in FIG. 4.As shown in FIG. 3, the total thickness of the fluorine-doped tin oxide coating increased by about 25% over the total thickness of prior tin coatings to a range of about 3800 Angstroms to about 4800 Angstroms when the gaseous mixture comprised about 3 cc/min to 9 cc/min of dimethyl sulfoxide (DMSO) at 33 lb./hr. of DMT.

It should be appreciated that such examples are for illustrative purposes only and are not to be construed as a limitation.

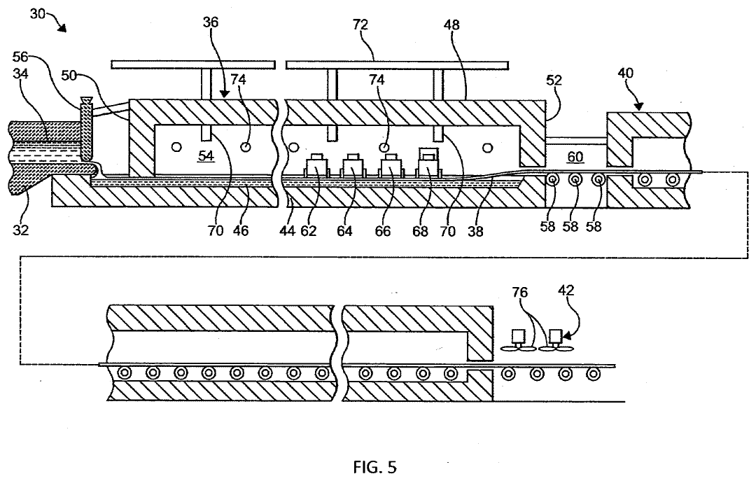

As discussed, above, the tin oxide coatings may be formed in conjunction with the manufacture of the glass substrate in the well-known float glass manufacturing process. The float glass manufacturing process may be typically carried out utilizing a float glass installation such as the installation 30 depicted in FIG. 5. However, it should be understood that the float glass installation 30 described herein is only illustrative of such installations.

As illustrated in FIG. 5, the float glass installation 30 may comprise a canal section 32 along which molten glass 34 may be delivered from a melting furnace, to a float bath section 36 where the glass substrate may be formed. In this embodiment, the glass substrate will be referred to as a glass ribbon 38. The glass ribbon 38 may be a preferable substrate on which the tin oxide coating may be formed. However, it should be appreciated that the glass substrate may not be limited to being a glass ribbon.

The glass ribbon 38 advances from the bath section 36 through an adjacent annealing lehr 40 and a cooling section 42. The float bath section 36 includes: a bottom section 44 within which a bath of molten tin 46 may be contained, a roof 48, opposite side walls (not depicted) and end walls 50, 52. The roof 48, side walls and end walls 50, 52 together define an enclosure 54 in which a non-oxidizing atmosphere may be maintained to prevent oxidation of the molten tin 46.

In operation, the molten glass 34 flows along the canal 32 beneath a regulating tweel 56 and downwardly onto the surface of the tin bath 46 in controlled amounts. On the molten tin surface, the molten glass 34 spreads laterally under the influence of gravity and surface tension, as well as certain mechanical influences, and it may be advanced across the tin bath 46 to form the glass ribbon 38. The glass ribbon 38 may be removed from the bath section 36 over lift out rolls 58 and may be thereafter conveyed through the annealing lehr 40 and the cooling section 42 on aligned rolls. The deposition of the tin oxide coating preferably takes place in the float bath section 36, although it may be possible for deposition to take place further along the glass production line, for example, in the gap 60 between the float bath 36 and the annealing lehr 40, or in the annealing lehr 40.

As illustrated in FIG. 5, a coating apparatus 62 may be shown within the float bath section 36. The tin oxide coating may be formed utilizing the coating apparatus 62. In this embodiment, the tin oxide coating may be formed directly on the glass substrate. In certain embodiments, the tin oxide coating may be formed over one or more coatings previously formed on the glass ribbon 38. Each of these coatings may be formed utilizing a separate coating apparatus. For example, in an embodiment, a coating layer comprising undoped tin oxide may be deposited utilizing a coating apparatus 62, 64. In another embodiment, a coating layer comprising undoped titanium dioxide may be deposited utilizing the coating apparatus 62, 64. It is understood that the tin oxide coating may be formed directly on or over the undoped tin oxide coating or the undoped titanium dioxide coating utilizing another coating apparatus 64-68, which may be positioned downstream of the coating apparatus 62, 64 utilized to form the undoped tin oxide coating or the undoped titanium dioxide coating, provided in the float bath section 36 or in another portion of the float glass installation 30 as described above. In another embodiment, a coating apparatus 66 may be provided and utilized to form a coating that comprises either fluorine-doped tin oxide or fluorine-doped titanium dioxide. In this embodiment, the tin oxide coating may be formed directly on or over the doped tin oxide coating or the doped titanium dioxide utilizing a coating apparatus 68 positioned downstream of the coating apparatus 66.

A suitable non-oxidizing atmosphere, generally nitrogen or a mixture of nitrogen and hydrogen in which nitrogen predominates, may be maintained in the float bath section 36 to prevent oxidation of the molten tin 46 comprising the float bath. The atmosphere gas may be admitted through conduits 70 operably coupled to a distribution manifold 72. The non-oxidizing gas may be introduced at a rate sufficient to compensate for normal losses and maintain a slight positive pressure, on the order of between about 0.001 and about 0.01 atmosphere above ambient atmospheric pressure, so as to prevent infiltration of outside atmosphere. For purposes of the describing the presently disclosed subject matter, the above-noted pressure range may be considered to constitute normal atmospheric pressure.

Preferably, the tin oxide coating may be formed at essentially atmospheric pressure. Thus, the pressure of the float bath section 36, annealing lehr 40, and/or in the gap 60 between the float bath section 36 and the annealing lehr 40 may be essentially atmospheric pressure.

Heat for maintaining the desired temperature regime in the float bath section 36 and the enclosure 54 may be provided by radiant heaters 74 within the enclosure 54. The atmosphere within the lehr 40 may be typically atmospheric air, as the cooling section 42 may not enclosed and the glass ribbon 38 may be therefore open to the ambient atmosphere. The glass ribbon 38 may be subsequently allowed to cool to ambient temperature. To cool the glass ribbon 38, ambient air may be directed against the glass ribbon 38 as by fans 76 in the cooling section 42. Heaters (not depicted) may also be provided within the annealing lehr 40 for causing the temperature of the glass ribbon 38 to be gradually reduced in accordance with a predetermined regime as it may be conveyed therethrough.

The foregoing description is considered as illustrative only of the principles of the presently disclosed subject matter. Further, since numerous modifications and changes will readily occur to those skilled in the art, it is not desired to limit the presently disclosed subject matter to the exact construction and processes shown and described herein. Accordingly, all suitable modifications and equivalents may be considered as falling within the scope of the presently disclosed subject matter.

1.-38. (canceled)

39. A chemical vapor deposition method for forming a tin oxide coating, comprising:
providing a glass substrate;
forming a precursor gaseous mixture comprised of at least one tin compound, a first oxygen-containing molecule, and at least one sulfur-containing compound;
directing the precursor gaseous mixture toward and along the glass substrate; and
reacting the precursor gaseous mixture to form the tin oxide coating over the glass substrate.

40. The method according to claim 39, wherein the at least one tin compound is at least one of dimethyltin dichloride, diethyltin dichloride, dibutyltin diacetate, tetra methyl tin, methyltin trichloride, triethytin chloride, trimethyltin chloride, ethyltin trichloride, propyltin trichloride, isopropyltin trichloride, sec-butyltin trichloride, t-butyltin trichloride, phenyltin trichloride, and carbethoxyethyltin trichloride, optionally wherein the at least one tin compound comprises dimethyltin dichloride.

41. The method according to claim 39, wherein the at least one sulfur-containing compound is an organic sulfur-containing compound, wherein the at least one sulfur-containing compound optionally is at least one of dimethyl sulfoxide and di-tert-butyl disulfide, and optionally wherein the at least one sulfur-containing compound is dimethyl sulfoxide.

42. The method according to claim 39, wherein a temperature of the glass substrate is at least 750° F. (399° C.) when the precursor gaseous mixture is reacted during the chemical vapor deposition process, and optionally wherein a temperature of the glass substrate is between about 840° F. (449° C.) and about 1300° F. (704° C.) when the precursor gaseous mixture is reacted during the chemical vapor deposition process.

43. The method according to claim 39, wherein the glass substrate comprises soda-lime-silica glass and/or wherein the glass substrate is formed by a float glass process.

44. The method according to claim 39, wherein the at least one sulfur-containing compound is added to the precursor gaseous mixture at a rate of at least 3 cc/min, optionally wherein the at least one sulfur-containing compound is added to the precursor gaseous mixture at a rate in range of about 3 cc/min to about 15 cc/min.

45. The method according to claim 39, wherein the precursor gaseous mixture is reacted over the glass substrate at essentially atmospheric pressure and/or wherein the glass substrate is moving when the tin oxide coating is deposited.

46. The method according to claim 39, wherein the tin oxide coating is an outermost layer of a coated glass article and/or wherein the tin oxide coating is formed over a previously deposited layer on the glass substrate.

47. The method according to claim 39, wherein the tin oxide coating has a thickness in a range of about 1200 Angstroms to about 1800 Angstroms, preferably in a range of about 1400 Angstroms to about 1625 Angstroms and/or wherein the first oxygen-containing molecule is molecular oxygen.

48. The method according to claim 39, wherein the tin oxide coating has a thickness in a range of about 1625 Angstroms to about 3000 Angstroms or wherein the tin oxide coating has a thickness in a range of about 25 Angstroms to about 2750 Angstroms.

49. The method according to claim 39, wherein the tin oxide coating has a sheet resistance in a range of about 250 ohms/square and 1000 ohms/square or wherein the tin oxide coating has a sheet resistance in a range of about 1250 ohms/square and 2250 ohms/square.

50. The method according to claim 39, wherein the precursor gaseous mixture further comprises a second oxygen-containing molecule, optionally wherein the second oxygen-containing molecule is water vapor.

51. The method according to claim 50, wherein the first oxygen-containing molecule is molecular oxygen and the second oxygen-containing molecule is water vapor and/or wherein the at least one tin compound is dimethyltin dichloride, the first oxygen-containing molecule is molecular oxygen, and the at least one sulfur-containing compound is dimethyl sulfoxide.

52. The method according to claim 39, wherein the precursor gaseous mixture further comprises a second oxygen-containing molecule, and wherein the at least one tin compound is dimethyltin dichloride, the first oxygen-containing molecule is molecular oxygen, the second oxygen-containing molecule is water vapor, and the at least one sulfur-containing compound is dimethyl sulfoxide and/or wherein the tin oxide coating is pyrolytic.

53. The method according to claim 39, wherein the precursor gas mixture further comprises at least one fluorine-containing compound, optionally wherein the at least one fluorine-containing compound is at least one of hydrofluoric acid and trifluoroacetic acid.

54. The method according to claim 39, wherein the precursor gaseous mixture further comprises a second oxygen-containing molecule and at least one fluorine- containing compound, and wherein the at least one tin compound is dimethyltin dichloride, the first oxygen-containing molecule is molecular oxygen, the second oxygen-containing molecule is water vapor, the at least one sulfur-containing compound is dimethyl sulfoxide, and the at least one fluorine-containing compound is hydrofluoric acid and/or wherein the tin oxide coating has a thickness in a range of about 3000 Angstroms to about 5000 Angstroms, preferably in a range of about 3800 Angstroms to about 4800 Angstroms.

55. The method according to claim 39, wherein the tin oxide coating has a sheet resistance in a range of about 8 ohms/square to about 14 ohms/square, or wherein the tin oxide coating has a sheet resistance in a range of about 16 ohms/square to about 20 ohms/square.

56. The method according to claim 39, wherein the molecular percentage of the one or more sulfur-containing compounds in the gaseous mixture is between 0.1 vol. % and 1.25 vol. %, preferably between 0.1 vol. % and 0.7 vol. %, more preferably between 0.1 vol. % and 0.5 vol. %, even more preferably between 0.1 vol. % and 0.3 vol. % when the gaseous mixture further comprises a second oxygen-containing molecule, or wherein the molecular percentage of the one or more sulfur-containing compounds in the gaseous mixture may be between 0.1 vol. % and 0.7 vol. % when the gaseous mixture does not comprise a second oxygen-containing molecule.

57. A method of coating a substrate, comprising:
providing a glass substrate; and
forming a tin oxide coating on the substrate using a chemical vapor deposition process,
wherein the chemical vapor deposition process utilizes a precursor gaseous mixture comprising at least one tin compound, a first oxygen-containing molecule, and at least one sulfur-containing compound,
wherein the at least one sulfur-containing compound acts as an accelerant for a reaction which forms the tin oxide coating over the glass substrate.

58. A coated glass article, comprising:
a glass substrate; and
a tin oxide coating deposited over the glass substrate by a chemical vapor deposition process utilizing a gaseous mixture comprising at least one tin compound, a first oxygen-containing molecule, and at least one sulfur-containing compound,
wherein the sulfur-containing compound acts as an accelerant for a reaction which forms the tin oxide coating over the glass substrate.
